(19) United States
(12) Patent Application Publication
(10) Pub. No.: US 2026/0104485 A1
(43) Pub. Date: Apr. 16, 2026

(54) RADAR SYSTEM WITH ENHANCED PROCESSING FOR INCREASED CONTRAST RATIO, IMPROVED ANGULAR SEPARABILITY AND ACCURACY, AND ELIMINATION OF GHOST TARGETS IN A SINGLE-SNAPSHOT

(71) Applicant: Robert Bosch Gmbh, Gerlingen (DE)

(72) Inventors: Andrew Graff, Austin, TX (US); Lun Chen, Round Rock, TX (US); Murtaza Ali, Cedar Park, TX (US); Jingning Tang, Pflugerville, TX (US); Suleyman Gokhun Tanyer, Victoria (CA); Paul W. Dent, Pittsboro, NC (US)

(21) Appl. No.: 19/419,374

(22) Filed: Dec. 15, 2025

Related U.S. Application Data
(63) Continuation of application No. 18/060,158, filed on Nov. 30, 2022, now Pat. No. 12,498,452.
(60) Provisional application No. 63/285,258, filed on Dec. 2, 2021.

(51) Int. Cl. G01S 7/292; G01S 7/35; G01S 13/02

(52) U.S. Cl. CPC G01S 7/2927; G01S 7/354; G01S 2013/0245

(57) ABSTRACT

A radar system with enhanced processing for increased contrast ratio, improved angular separability and accuracy, and elimination of ghost targets. The radar system is equipped with transmitters, receivers, and transmit antennas and receive antennas with respective array configurations. The radar system iteratively detects target(s) by first finding the strongest target, subtracting the estimated received signal from the detected target, and repeating the process for subsequent targets until an exit condition is reached. The enhanced processing's subtraction of estimated received signals increases the contrast ratio of detectable targets. The detection is thus refined by determining optimal azimuth, elevation, gain, and phase of each detection through a joint optimization of all detections. The subtraction and refinement aid in eliminating ghost targets by removing sidelobe signals and residual errors.

### CROSS REFERENCE TO RELATED APPLICATION

The present application claims priority to and is a continuation of U.S. patent application Ser. No. 18/060,158, filed Nov. 30, 2022, which claims the benefits of U.S. provisional application, Ser. No. 63/285,258, filed Dec. 2, 2021, which are hereby incorporated by reference herein in their entireties.

### FIELD OF THE INVENTION

The present invention is directed to radar systems, and more particularly to radar systems for vehicles and robotics.

### BACKGROUND OF THE INVENTION

The use of radar to determine direction, range, and velocity of objects in an environment is important in a number of applications including automotive radar, robotic sensing, and positioning. The performance of these radars is often limited by the angular separability, contrast ratio, accuracy, and presence of ghost targets when using standard processing chains.

### SUMMARY OF THE INVENTION

Methods and systems of the present invention provide for a radar system that implements an enhanced processing chain to detect targets beyond the detectable contrast of conventional radar with improved angular separability, accuracy, and a reduction in the presence of ghost targets. The processing chain of the radar detects the strongest target, subtracts the signal contribution from that target from the measured antenna responses, then continues to detect additional targets that may have been previously undetectable before signal subtraction. Before each subtraction, the processing chain of the radar jointly optimizes its estimated parameters of all previous detections. These estimated parameters are not limited to the target azimuth, elevation, magnitude, and phase. The joint estimation reduces residual errors which prevents ghost targets from being detected.

In a radar system of the present invention for a robot or vehicle that uses an enhanced processing chain includes at least one transmitter, at least one receiver, and at least one antenna. The transmitter is configured to transmit radio signals. The receiver is configured to receive a reflected radio signal. The reflected radio signal is the transmitted radio signal(s) reflected from an object or multiple objects in an environment. The at least one receiver is also configured to receive radio signals transmitted by other similar systems.

A radar system of the present invention with enhanced processing for increased contrast ratio, improved angular separability and accuracy, and elimination of ghost targets includes transmitters, receivers, pluralities of transmit antennas, and pluralities of receive antennas. The enhanced processing chain on-board the radar system iteratively detects target(s) by first finding the strongest target, subtracting the estimated received signal from the detected target, and repeating the process for subsequent targets until a predefined number of iterations is completed or an exit condition is tripped. The enhanced processing chain's subtraction increases the contrast ratio of detectable targets. The detection is thus refined by determining optimal azimuth, elevation, gain, and phase of each detection through a joint optimization of all detections. The subtraction and refinement aid in eliminating ghost targets by removing sidelobe signals and residual errors that cause ghost targets to appear.

In an aspect of the present invention, the radar system performs the enhanced detection for multiple targets at any combination of range distances, Doppler velocities, azimuth angles, and elevation angles within the radar system's operable limits.

In another aspect of the present invention, the radar system modifies its enhanced processing chain to optimize different objective functions. These modifications include detection thresholds, the number of iterations used in joint estimation, a method of performing joint estimation, and a beamforming codebook.

In a further aspect of the present invention, the radar system executes the entirety of the enhanced detection algorithm on the data collected within a single snapshot. A single snapshot refers to a single time-instance of radar data collection.

These and other objects, advantages, purposes and features of the present invention will become apparent upon review of the following specification in conjunction with the drawings.

### BRIEF DESCRIPTION OF THE DRAWINGS

FIG. 1A and FIG. 1B are block diagrams of radar systems in accordance with the present invention;

FIG. 2 is a block diagram illustrating a radar system with a plurality of receivers and a plurality of transmitters (MIMO radar) in accordance with the present invention;

FIG. 3 is a signal diagram illustrating the beamformed response of 2 antenna array geometries with 2 targets present with a high contrast ratio in power in accordance with the present invention;

FIG. 4 is a signal diagram illustrating the beamformed response of 2 antenna array geometries with 2 targets present with small separations between themselves, showing a bias in angular estimation in accordance with the present invention;

FIG. 5 is a signal diagram illustrating the beamformed response of 2 antenna array geometries with 2 targets present with small separations between themselves, showing the disambiguation between targets, in accordance with the present invention;

FIG. 6A is a flow diagram illustrating the steps to a method for an enhanced detection procedure, in accordance with the present invention;

FIG. 6B is a flow diagram illustrating the steps to a method for performing a step of the method illustrated in FIG. 6A in accordance with the present invention;

FIG. 7 is a signal diagram illustrating the sum-of-squared residual minimization performed by the enhanced detection procedure during the estimation of detection parameters in accordance with the present invention;

FIG. 8 is a diagram illustrating an exemplary uniform rectangular antenna array geometry and an exemplary beam response pattern of such an array geometry, in accordance with the present invention;

FIG. 9 is a diagram illustrating an exemplary sparse antenna array geometry and an exemplary beam response pattern of such an array geometry in accordance with the present invention; and

FIG. 10 is diagram illustrating an exemplary detection using a conventional detection algorithm and using the enhanced detection procedure, showing the removal of ghost targets in accordance with the present invention.

### DESCRIPTION OF THE PREFERRED EMBODIMENTS

The present invention will now be described with reference to the accompanying figures, wherein numbered elements in the following written description correspond to like-numbered elements in the figures. Methods and systems of the present invention achieve increased angular separability, contrast ratios, improved accuracy, and elimination of ghost targets.

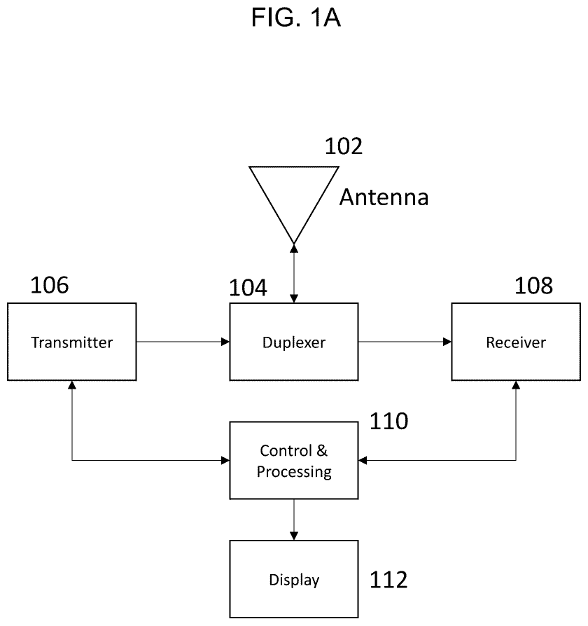

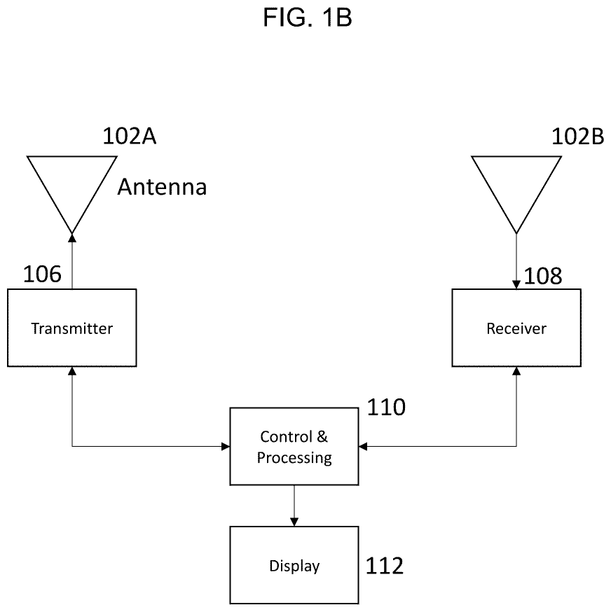

FIG. 1A illustrates an exemplary radar system 100 with an antenna 102 that is time-shared between a transmitter 106 and a receiver 108 via a duplexer 104. As also illustrated in FIG. 1A, output from the receiver 108 is received by a control and processing module 110 that processes the output from the receiver 108 to produce display data for the display 112. The control and processing module 110 is also operable to produce a radar data output that is provided to other control units. The control and processing module 110 is also operable to control the transmitter 106.

FIG. 1B illustrates an alternative exemplary radar system 150 with a pair of antennas 102a, 102b: an antenna 102a for the transmitter 106 and another antenna 102b for the receiver 108.

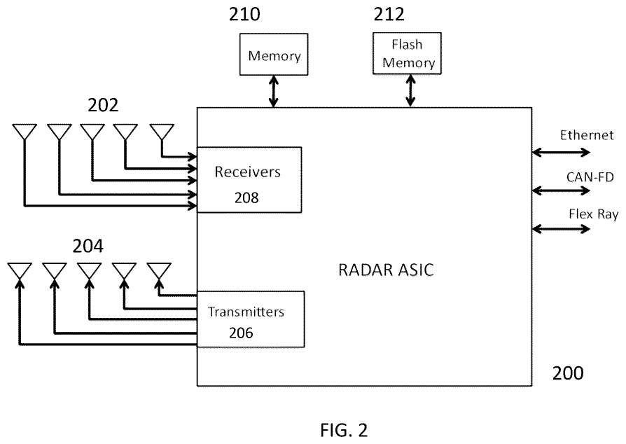

An exemplary MIMO radar system is illustrated in FIG. 2. With MIMO radar systems, each transmitter signal is rendered distinguishable from every other transmitter by using appropriate differences in the modulation, for example, different digital code sequences. Each receiver correlates with each transmitter signal, producing a number of correlated outputs equal to the product of the number of receivers with the number of transmitters. The outputs are deemed to have been produced by a number of virtual receivers, which can exceed the number of physical receivers.

FIG. 2 illustrates an exemplary radar system 200 with multiple antennas 202, 204, transmitters 206 and receivers 208. Using multiple antennas allows a radar system 200 to determine the angle of objects/targets in the environment. Depending on the geometry of the antenna system 200, different angles (e.g., with respect to the horizontal or vertical) can be determined. The radar system 200 may be connected to a network via an Ethernet connection or other types of network connections 214. The radar system 200 includes memory 210, 212 to store software used for processing the received radio signals to determine range, velocity, and location of objects/targets in the environment. Memory may also be used to store information about objects/targets in the environment.

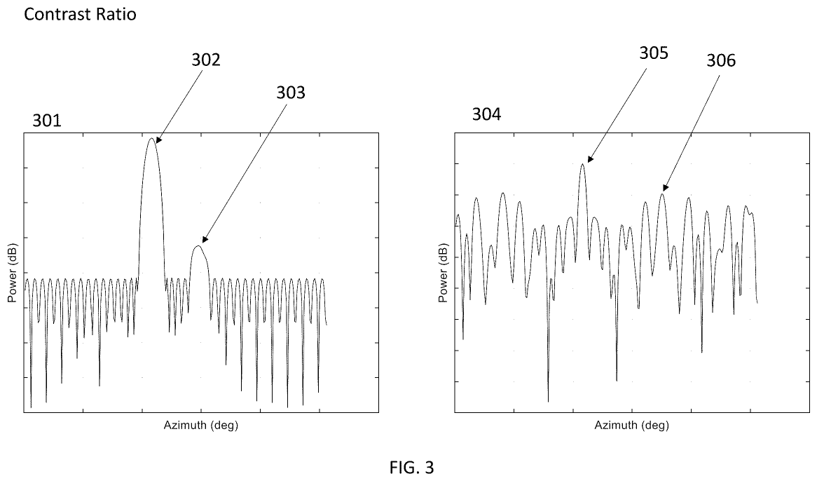

FIG. 3 is a diagram of the beam response of 2 array geometries, the first response 301 being from a uniform linear array and the second response 304 being from a non-uniform array. The highest power target is detectable from the response (i.e., signal peaks 302, 305) from both the uniform array (301) and the non-uniform array (304). However, the lowest power target is only detectable in the response (i.e., signal peak 303) of the uniform array (301). The response 304 of the non-uniform array exhibits significant sidelobes 306 which have a stronger power than that of the lowest power target. Therefore, conventional detection algorithms are incapable of detecting the lowest power target using the non-uniform array.

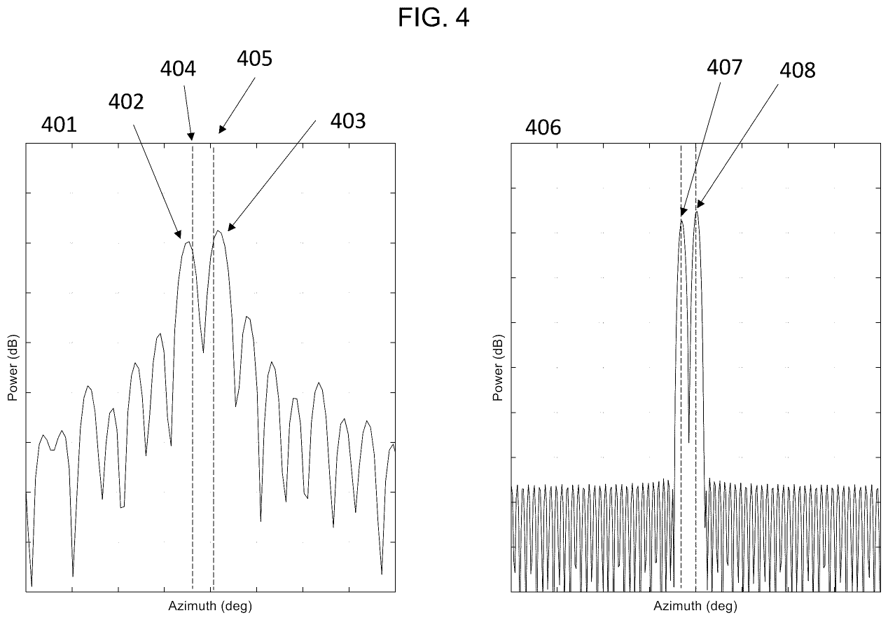

FIG. 4 is a diagram of the beam response of 2 array geometries with 2 targets present with equal power and a moderate angular separation. The first response 401 is from conventional beamforming on a uniform array in the presence of noise. The second response 406 is generated from the detections of the enhanced detection procedure. In the first response 401, both targets are detectable 402, 403, but exhibit a bias in angle from their true positions (404, 405, respectively). In the ideal array response, the larger aperture tightens the beams thereby reducing the angular bias in the positions of the 2 targets 407, 408.

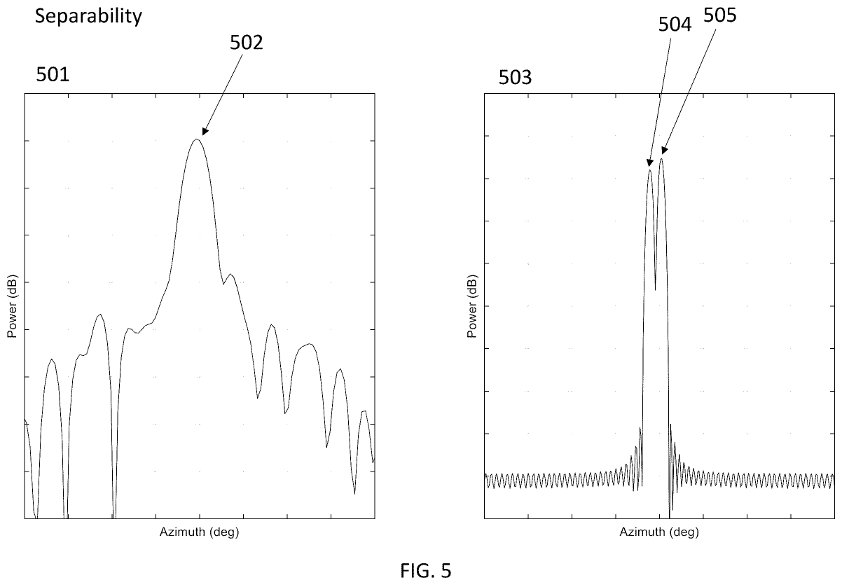

FIG. 5 is a diagram of the beam response of 2 array geometries with 2 targets present with equal power and a small angular separation. The first response 501 is from conventional beamforming on a uniform array in the presence of noise. The second response 503 is generated from the detections of the enhanced detection procedure. In the first response 501, the 2 targets are indistinguishable and only appear as a single target (i.e., signal peak 502). In the second response 503, both targets (i.e., signal peaks 504, 505) are clearly distinguishable.

The radar data is described by the following exemplary mathematical model. Denoting αz and el as the azimuth and elevation angles (in radians) to the target, define the u-v space as:

$$u = sin ( az ) cos ( el )$$

$$v = sin ( el )$$

Let there be K targets within a single range-doppler bin. Each target has a complex magnitude αₖ and u-v position of (uₖ, νₖ). Let there be N array elements, with positions (pₙ, qₙ). The array response from all targets is defined as:

$${y}_{n} = {\sum }_{k = 1}^{K} {α}_{k} exp ( j 2 π {p}_{n} {u}_{k} ) exp ( j 2 π {q}_{n} {v}_{k} )$$

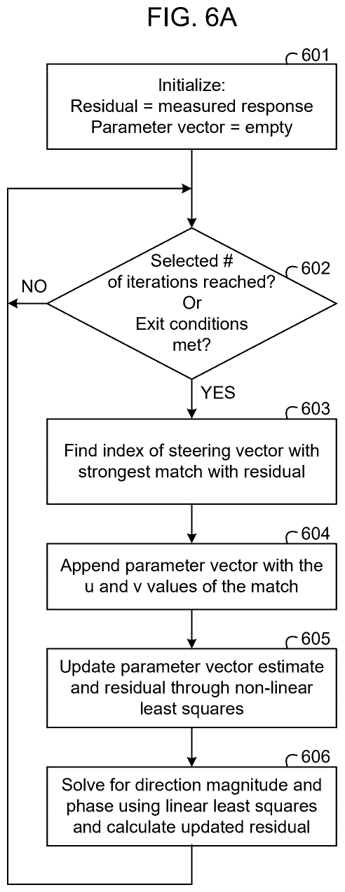

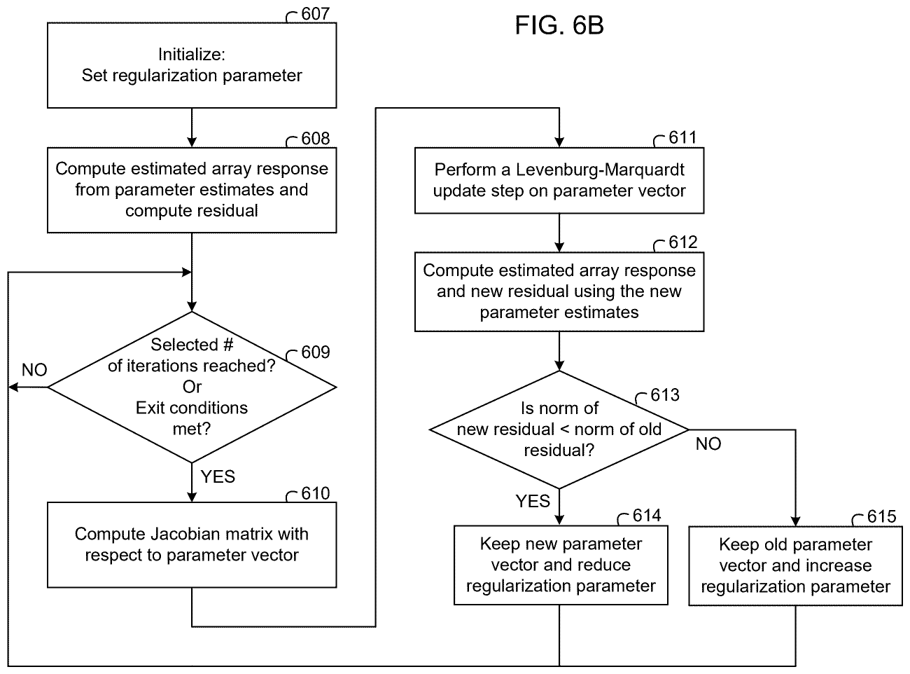

FIGS. 6A and 6B are flow diagrams illustrating the steps of an exemplary enhanced detection procedure or algorithm. The algorithm keeps track of two key variables. First is a residual vector, which is the error between the expected response of the estimated detections and the actual measured antenna array response. Second is a parameter vector, which stores the u and v values of the detections. In step 601 of FIG. 6, the residual vector is initialized to the measured antenna array response, and the parameter vector is initialized to be empty. In step 602 of FIG. 6A, a loop begins which executes a predefined number of object detection iterations or until an exit condition is tripped. The exit conditions include but are not limited to 1) the maximum beamformed output of residual falling below a predefined threshold, or 2) the ratio of maximum beamformed output of residual to the mean beamformed output of residual falling below a predefined threshold, or 3) the residual norm squared decreasing (relative to the prior iteration) less than a predefined threshold. In step 603 of FIG. 6A, the beamformed response of the residual vector is computed for a predefined set of steering vectors. The power of the beamformed response is computed for each steering vector. The maximum and mean power is computed to assess if exit condition(s) are tripped. If exit condition(s) are not tripped, the u-v values corresponding to the highest power beamformed response is recorded as the parameters for a new detection. In step 604 of FIG. 6A, these parameters are stored into the parameter vector. In step 605 of FIG. 6A, a non-linear least squares subroutine is called to update the parameter vector. In step 606 of FIG. 6A, the magnitude and phase of each detection are calculated using linear least squares and the residual or error is updated by subtracting the aggregate expected array response from the actual measured antenna array response.

The non-linear least squares subroutine of step 605 of FIG. 6A begins with step 607 of FIG. 6B, where a regularization parameter is initialized. In step 608 of FIG. 6B, the expected array response is computed given the current number of detections and their parameters. This step includes an estimation of the complex amplitudes through linear least squares. Then a loop begins in step 609 of FIG. 6B, which executes for a set number of iterations or until an exit condition is tripped. The exit condition includes, but is not limited to, the residual norm squared decreasing (relative to the prior iteration) less than a predefined threshold. In step 610 of FIG. 6B, a Jacobian matrix is created which contains the partial derivatives of the expected array response with respect to the parameters in the parameter vector. In step 611 of FIG. 6B, a Levenberg-Marquardt update step is taken using the computed Jacobian matrix. In step 612 of FIG. 6B, the expected array response is again computed using the new parameter estimates and an updated residual is calculated. In step 613 of FIG. 6B, a decision is made based on whether the new parameter vector reduced the norm of the residuals. If it did, then in step 614 of FIG. 6B, the update is accepted, and the regularization parameter is reduced. Additionally, the exit condition(s) are checked, and the loop exits if any exit condition is tripped. If not, then in step 615 of FIG. 6B, the update is rejected, and the regularization parameter is increased. Alternative variations of the procedure may always accept updates or not use any regularization.

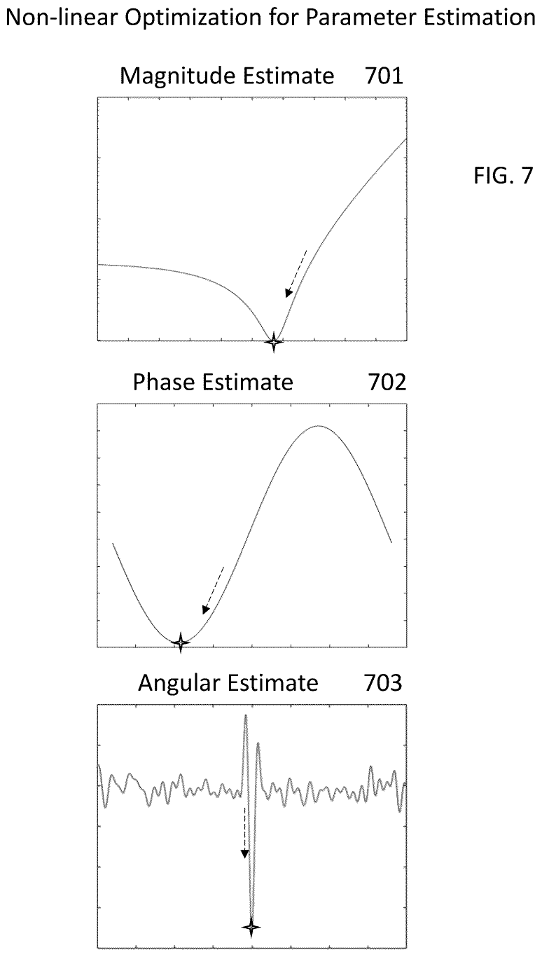

FIG. 7 is a diagram illustrating exemplary plots of the norm of the residual error as a function of a detection's parameters, namely magnitude (701), phase (702), and angle (703). The non-linear least squares subroutine attempts to find the global minima with respect to these parameters. The steering vectors in the matching step are selected to provide a close enough initial estimate of the u-v parameters that the subroutine operates within the convex region of the angular estimate.

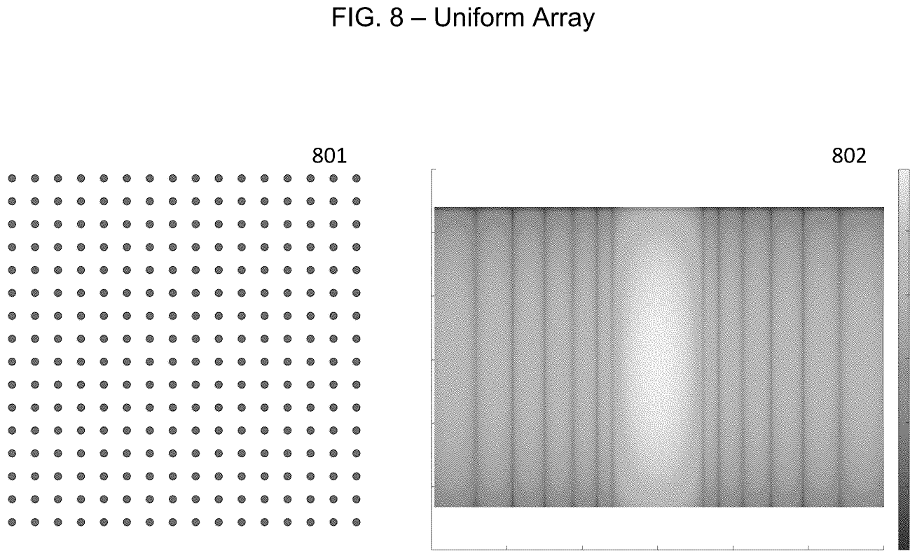

FIG. 8 is a diagram illustrating an exemplary antenna array geometry of a uniform rectangular array 801 and a beamformed response 802 at boresight. The beamformed response 802 shows a wide mainlobe. Relative to the mainlobe power, the sidelobe level is manageably low.

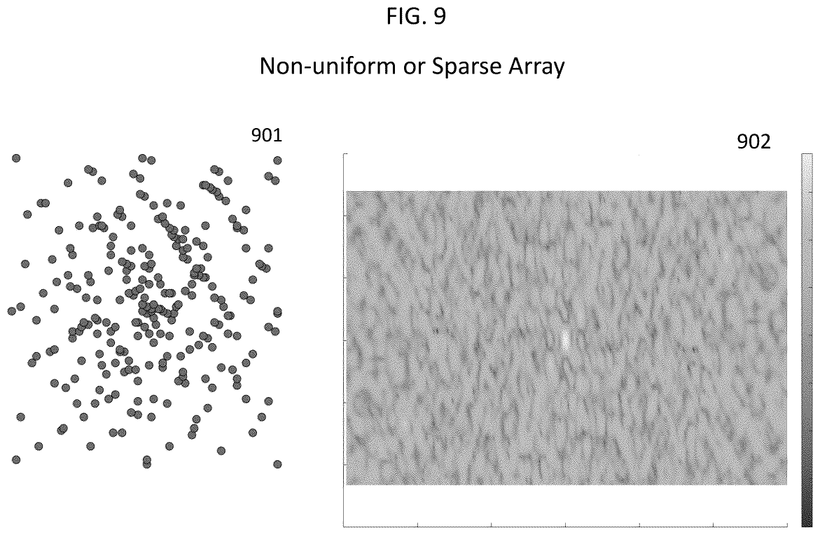

FIG. 9 is a diagram illustrating an exemplary antenna array geometry of a sparse array 901 and a beamformed response 902 at boresight. Using the same number of antennas as in FIG. 8, the sparse array's geometry 901 creates a different beamformed response 902. In comparison to the beamformed response 802, the mainlobe in uniform rectangular array 801 is significantly narrower. Relative to the mainlobe, the sidelobe level is increased in the beamformed response 902 compared to the sidelobe level in beamformed response 802. The enhanced detection procedure allows the array in the sparse array 901 to detect targets below its sidelobe level, allowing array designs to be used that provide benefits in beamwidth and therefore angular resolution.

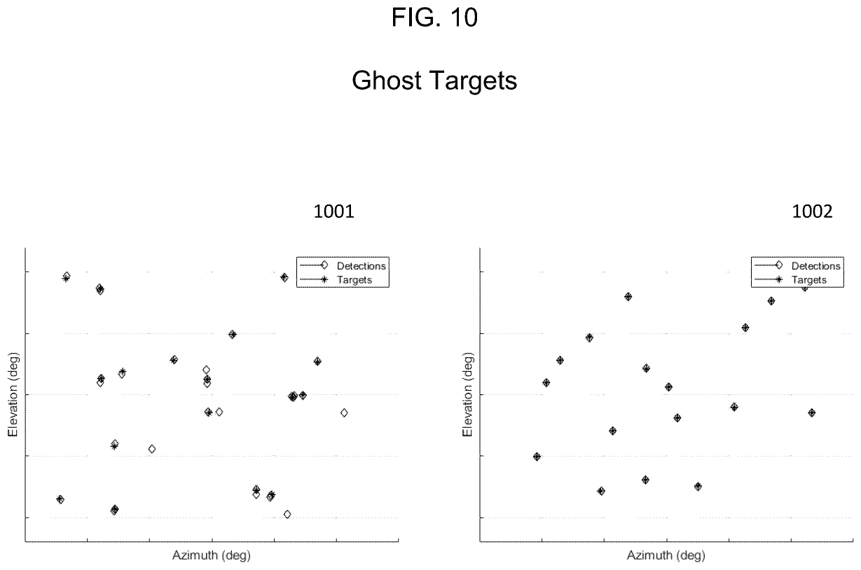

FIG. 10 is a diagram illustrating an exemplary detection of targets without joint parameter estimation 1001 and with joint parameter estimation 1002 following the enhanced detection procedures. In the joint parameter estimation 1001, there are numerous ghost detections that do not correspond to actual targets. The detections also have notable angular error. In the joint parameter estimation 1002, the number of ghost detections and the angular error are both reduced significantly.

Thus, as discussed herein, exemplary radar receivers are configured to perform an enhanced object detection procedure allowing for the detection of objects with signal strengths below a given array's sidelobe signal levels (and thus reducing the number of ghost detections). Accordingly, array designs may be used that provide benefits in beamwidth and angular resolution by iteratively enhancing object detection such that the collected radar data comprises residual vectors with increasingly smaller errors between the expected response of estimated detections and actual measured responses.

Changes and modifications in the specifically described embodiments can be carried out without departing from the principles of the present invention, which is intended to be limited only by the scope of the appended claims, as interpreted according to the principles of patent law including the doctrine of equivalents.

1. A radar system comprising:
a transmitter configured to transmit radio signals;
a receiver configured to receive radio signals that include the transmitted radio signals transmitted by the transmitter and reflected from objects in an environment;
wherein the receiver is configured to perform an iterative target detection process on the received radio signals to detect successively weaker targets, wherein the receiver is configured to detect a strongest target in the received radio signals, subtract an estimated received signal from the detected target signal to calculate a residual error, and repeatedly detect a next strongest target and subtract the corresponding estimated received signal from the next detected target signal until an exit condition for ending the iterative target detection process is reached.

2. The radar system of claim 1, wherein the receiver is configured to receive radio signals transmitted by other radar systems, wherein the other radar systems comprise a known radar system, and wherein the transmitter and the receiver are configured for use in a robot and/or a vehicle.

3. The radar system of claim 1, wherein the receiver is configured to end the iterative target detection process when one of a plurality of exit conditions is reached, wherein the exit condition for ending the iterative target detection process is one of the plurality of exit conditions, and wherein a first exit condition of the plurality of exit conditions comprises a completion of a selected quantity of iterations.

4. The radar system of claim 3, wherein the exit condition to end the iterative target detection process provides for the detection of targets in the received radio signals that are detectable with signal strengths below a given sidelobe signal level.

5. The radar system of claim 1, wherein iteratively subtracting estimated received signals from detected target signals incrementally increases the contrast ratio of detectable targets.

6. The radar system of claim 1, wherein the receiver is configured to calculate radar data comprising increasingly smaller residual errors between an expected response of estimated detections and actual measured responses.

7. The radar system of claim 1, wherein the receiver is configured to perform the iterative target detection process to first perform conventional beamforming to find approximate parameters of a target and to then perform a joint estimation of target parameters for all targets for each new detection added to a detection list.

8. The radar system of claim 7, wherein the approximate parameters comprise azimuth/elevation angles, magnitudes, and phase of the target.

9. The radar system of claim 7, wherein the receiver is configured to take a ratio of a maximum conventional beamforming output to a mean conventional beamforming output and compare this ratio to a predetermined threshold and use the result as another exit condition of the plurality of exit conditions of the target detection process.

10. The radar system of claim 7, wherein the receiver is configured to compare a change in a residual norm between the current and prior iteration to a predefined threshold and to use the result as another exit condition of the plurality of exit conditions of the target detection process.

11. The radar system of claim 7, wherein the receiver is configured to compare a change in a residual norm between the current and prior iteration to a predefined threshold and the result is used as another exit condition of the plurality of exit conditions of the target detection process and to end the joint estimation.

12. The radar system of claim 1, wherein the receiver is configured to execute the entirety of an enhanced detection algorithm on the data collected within a single snapshot, and wherein the single snapshot is a single time-instance of radar data collection.

13. The radar system of claim 6, wherein the receiver is configured to modify the iterative target detection process to selectively optimize different objective functions comprising at least one of detection thresholds, number of iterations used in joint estimation, and beamforming.

14. The radar system of claim 6, wherein a target undetectable in the received radio signals from an antenna array configured as a non-uniform array that is detectable from an antenna array configured as a uniform array is detectable when the receiver is configured to perform the iterative detection process and is thereby operable to detect targets below its sidelobe level, such that the selected antenna array configuration is selected for a selected beamwidth and angular resolution.

15. The radar system of claim 14, wherein the receiver is configured to perform enhanced target detection to detect targets with signal strengths below a given antenna array's sidelobe signal levels.

16. A radar system comprising:
a plurality of transmitters configured to transmit radio signals;
a plurality of receivers configured to receive radio signals that include the transmitted radio signals transmitted by the transmitters and reflected from objects in an environment;
wherein the receivers are configured to detect a first target and to subtract a signal contribution from the first target from a measured antenna response, and to then iteratively detect one or more additional targets with signal strengths that are weaker than the first target and which were previously undetectable before signal subtraction and subtract corresponding signal contributions from the one or more additional targets from the measured antenna response until an exit condition is reached.

17. The radar system of claim 16, wherein the receivers are configured to jointly optimize estimated parameters of all previous detections before each subtraction, and wherein the receivers are configured to use the joint estimation to reduce residual errors and thereby prevent ghost targets from being detected by the receivers.

18. The radar system of claim 17, wherein the estimated parameters comprise target azimuth, elevation, magnitude, and phase, and wherein the subtraction of the signal contribution increases a contrast ratio of detectable targets.

19. The radar system of claim 17, wherein the receivers are configured to jointly optimize the estimated parameters through a joint optimization of all target detections, thereby increasing the accuracy of the radar system, and wherein the target subtraction and refinement both aid in eliminating ghost targets by removing sidelobe signals and residual errors which cause ghost targets to appear.

20. The radar system of claim 17, wherein the receivers are configured to receive radio signals transmitted by other radar system comprising at least one known radar system, and wherein the transmitters and receivers are each configured for use in a robot and/or a vehicle.
